(19) United States
(12) Patent Application Publication
(10) Pub. No.: US 2024/0386909 A1
(43) Pub. Date: Nov. 21, 2024

(54) BASE PLATE, SPINDLE MOTOR, DISK DRIVE DEVICE, AND METHOD FOR MANUFACTURING BASE PLATE

(71) Applicant: NIDEC CORPORATION, Kyoto (JP)

(72) Inventors: Michihiro ITO, Kyoto (JP); Kenta MIYOSHI, Kyoto (JP); Ryo FURUYA, Kyoto (JP); Toshihiro HIRASAWA, Kyoto (JP)

(73) Assignee: NIDEC CORPORATION, Kyoto (JP)

(21) Appl. No.: 18/691,462

(22) PCT Filed: Sep. 14, 2022
(86) PCT No.: PCT/JP2022/034466

§ 371 Date: Mar. 13, 2024

(30) Foreign Application Priority Data
Sep. 14, 2021 (JP) 2021-149698
Sep. 14, 2021 (JP) 2021-149699

(51) Int. Cl. G11B 5/53; H02K 5/06; H02K 15/14

(52) U.S. Cl. CPC G11B 5/531; H02K 5/06; H02K 15/14

(57) ABSTRACT

This base plate constitutes a part of a housing of a disk drive device, and is formed from a metal plate and a die-cast part. The metal plate includes a board-shaped bottom plate portion that spreads out perpendicular to an up-down extending axis of rotation of a disk. The die-cast part covers at least a part of the bottom plate portion. Metal which constitutes the bottom plate portion is higher in rigidity than metal which constitutes the die-cast part.

### TECHNICAL FIELD

The invention relates to a base plate, a spindle motor, a disk drive device, and a method for manufacturing a base plate.

### RELATED ART

A base (base plate) configured as a portion of a housing of a conventional disk drive device is formed by casting a die-cast member. A spindle motor is fixed onto the base. The spindle motor rotates multiple disks with a rotation axis as the center (see, for example, Patent Document 1).

In addition, an actuator installation part (pivot post) is provided. The actuator installation part protrudes upward from the upper surface of a bottom surface part (see, for example, Patent Document 2).

### PRIOR ART DOCUMENT(S)

### Patent Document(s)

[Patent Document 1] Japanese Laid-open No. 2020-129423
[Patent Document 2] Japanese Laid-open No. 2015-127064

### SUMMARY OF INVENTION

### Issues to be Solved by the Invention

However, in the disk drive device disclosed in Patent Document 1, if the base is thinned, the strength of the housing may be reduced. In addition, in a case body disclosed in Patent Document 2, during casting, the flow of metal to the actuator installation part is poor, and shrinkage cavities may occur in the actuator installation part. Therefore, it is possible that gas filled into the housing may leak to the outside via the actuator installation part.

An objective of the invention is to provide a base plate and a method for manufacturing the base plate capable of being thinned while preventing strength from being reduced, as well as a base plate and a method for manufacturing the base plate capable of preventing gas leakage of a disk drive device.

### Means for Solving the Issues

An exemplary base plate of a first invention for solving the issue is a base plate configured as a portion of a housing of a disk drive device and is formed by a metal plate and a die-cast part. The metal plate has a bottom plate part. The bottom plate part has a plate shape and spreads vertically with respect to a rotation axis of a disk extending in an upper-lower direction. The die-cast part covers at least a portion of the bottom plate part. A metal forming the bottom plate part is higher in rigidity than a metal forming the die-cast part.

An exemplary base plate of a second invention for solving the issue is a base plate configured as a portion of a housing of a disk drive device and includes a die-cast part and a pivot post. The die-cast part is formed by a die-cast member. The die-cast part has a bottom surface part spreading vertically with respect to a rotation axis of a disk extending in an upper-lower direction. The pivot post is disposed at a position different from the rotation axis and protrudes upward from an upper surface of the bottom surface part along a swing axis of a head performing information reading or information writing with respect to a disk to extend in an upper-lower direction. The pivot post is a separate member from the die-cast part. A metal forming the pivot post is more rigid than a metal forming the bottom plate part.

An exemplary of a method for manufacturing a base plate according to a first invention is a method for manufacturing a base plate as a portion of a housing of a disk drive device sequentially includes a casting process, an electro-coating process, and a cutting process. In the casting process, a metal plate and a die-cast part are cast by using a mold. The metal plate has a bottom plate part and a peripheral plate part. The bottom plate part has a plate shape and spreads vertically with respect to a rotation axis of a disk extending in an upper-lower direction. The peripheral plate part extends upward from an outer edge of the bottom plate part and surrounds a periphery of the bottom plate part. The die-cast part covers at least a portion of the bottom plate part and the peripheral plate part. In the electro-coating process, an electro-coating film is formed at least in the die-cast part and a portion of the metal plate. In the cutting process, the surface of the die-cast part is cut.

An exemplary of a method for manufacturing a base plate according to a second invention is a method for manufacturing a base plate as a portion of a housing of a disk drive device sequentially includes a casting process, a removing process, and an electro-plating process. In the casting process, a pivot post is placed in a mold to inject molten metal and a die-cast part having a bottom surface part spreading vertically with respect to a rotation axis of a disk extending in an upper-lower direction is formed. The pivot post extends in the upper-lower direction by protruding upward from an upper surface of the bottom surface part along a swing axis of a head that performs information reading or information writing with respect to a disk. In the removing process, a gate mark part linked with the die-cast part is removed. In the electro-coating process, an electro-coating film is formed on a surface of the die-cast part and the metal plate.

### Inventive Effects

According to the exemplary first invention, the base plate able to be thinned while preventing the strength from being reduced and the spindle motor and the disk drive device using the base plate can be provided.

In addition, a method for manufacturing the base plate able to be thinned while preventing the strength from being reduced can be provided.

According to the exemplary second invention, a base plate capable of gas leakage of a disk drive device, a spindle motor using the base plate, and a method for manufacturing the base plate can be provided. In addition, a disk drive device capable of preventing gas leakage can provided.

### BRIEF DESCRIPTION OF DRAWINGS

FIG. 1 is a longitudinal cross-sectional view of a disk drive device according embodiments of first and second inventions.

FIG. 2 is a perspective view of a base plate according to the embodiments of the first and second inventions.

FIG. 3 is a cross-sectional perspective view of the base plate according to the embodiments of the first and second inventions.

FIG. 4 is a perspective view of a metal plate according to the embodiments of the first and second inventions.

FIG. 5 is an enlarged cross-sectional perspective view illustrating a portion of the base plate according to the embodiments of the first and second inventions.

FIG. 6 is a flowchart illustrating a manufacturing process of the base plate according to the embodiment of the first invention.

FIG. 7 is a schematic view illustrating the manufacturing process of the base plate according to the embodiment of the first invention.

FIG. 8 is a schematic view illustrating the manufacturing process of the base plate according to the embodiment of the first invention.

FIG. 9 is a schematic view illustrating the manufacturing process of the base plate according to the embodiment of the first invention.

FIG. 10 is a schematic view illustrating the manufacturing process of the base plate according to the embodiment of the first invention.

FIG. 11 is a schematic view illustrating the manufacturing process of the base plate according to the embodiment of the first invention.

FIG. 12 is a schematic view illustrating the manufacturing process of the base plate according to the embodiment of the first invention.

FIG. 13 is a schematic view illustrating the manufacturing process of the base plate according to the embodiment of the first invention.

FIG. 14 is an enlarged cross-sectional perspective view illustrating a portion of the base plate according to the embodiment of the second invention.

FIG. 15 is an enlarged front cross-sectional view illustrating a pivot post of the base plate according to the embodiment of the second invention.

FIG. 16 is a flowchart illustrating the manufacturing process of the base plate according to the embodiment of the second invention.

FIG. 17 is a schematic view illustrating the manufacturing process of the base plate according to the embodiment of the second invention.

FIG. 18 is a schematic view illustrating the manufacturing process of the base plate according to the embodiment of the second invention.

FIG. 19 is a schematic view illustrating the manufacturing process of the base plate according to the embodiment of the second invention.

FIG. 20 is a schematic view illustrating the manufacturing process of the base plate according to the embodiment of the second invention.

FIG. 21 is a schematic view illustrating the manufacturing process of the base plate according to the embodiment of the second invention.

FIG. 22 is a schematic view illustrating the manufacturing process of the base plate according to the embodiment of the second invention.

FIG. 23 is a schematic view illustrating the manufacturing process of the base plate according to the embodiment of the second invention.

FIG. 24 is a schematic view illustrating a manufacturing process of a base plate according to a modified example on the basis of the embodiment of the second invention.

FIG. 25 is an enlarged front cross-sectional view illustrating a pivot post of a modified example of the base plate according to the embodiment of the second invention.

### DESCRIPTION OF EMBODIMENTS

Hereinafter, exemplary embodiments of the invention will be described in detail with reference to the drawings. In the description, a direction parallel to a rotation axis C is referred to as “axial direction”, a direction perpendicular to the rotation axis C is referred to as “axial direction”, and a direction along an arc with the rotation axis C as the center is referred to as “peripheral direction”. In addition, in the application, the shape and positional relationship of each part are described with the axial direction as the upper-lower direction, the side of a cover 42 being upper with respect to a base plate 41. However, the definition of the upper-lower direction does not intend to limit the orientation when the base plate 41 and a disk drive device 1 according to the invention are used.

### 1. Configuration of a Disk Drive Device

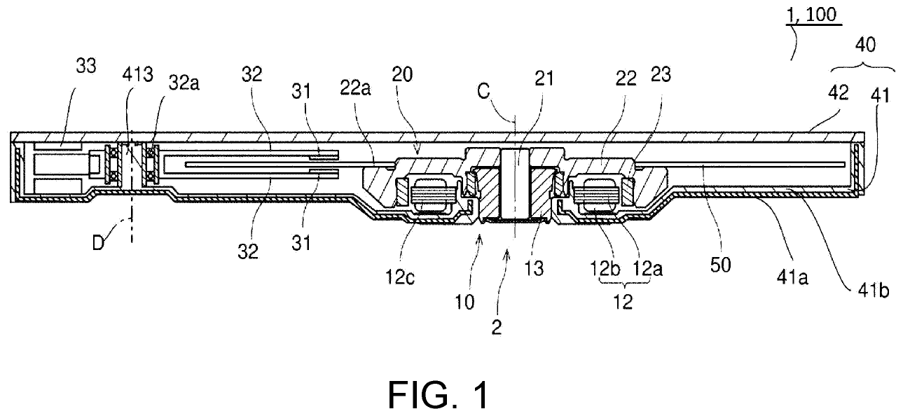

The disk drive device 1 according to an exemplary embodiment of the invention is described as follows. FIG. 1 is a longitudinal cross-sectional view of the disk drive device 1 according an embodiment of first invention.

The disk drive device 1 is a hard disk drive. The disk drive device 1 includes a spindle motor 2, a disk 50, a head 31, an arm 32, a swing mechanism 33, and a housing 40.

The housing 40 accommodates therein the spindle motor 2, the disk 50, the head 31, and the arm 32.

The inside of the housing 40 is filled with gas with a density lower than air. Specifically, helium gas is filled therein. Nevertheless, the inside of the housing 40 may also be filled by hydrogen gas, etc., in place of helium gas.

The housing 40 has the base plate 41 and the cover 42. Inside the housing 40, the disk 50, the spindle motor 2, and an access part 30 are disposed on the base plate 41. An opening of an upper part of the base plate 41 is blocked by the cover 42. The base plate 41 will be described in detail in the following.

The spindle motor 2 rotates the disk 50 with the rotation axis C as the center while supporting the disk 50. That is, the disk 50 rotates with the rotation axis C as the center by using the spindle motor 2. The spindle motor 2 has a stationary part 10 and a rotation part 20. The stationary part 10 is stationary relative to the housing 40. The rotation part 20 is rotatably supported by the stationary part 10.

The stationary part 10 has a stator 12 and a bearing unit 13. In addition, a portion of the base plate 41 forms the stationary part 10. That is, the spindle motor 2 includes the base plate 41. The base plate 41 spreads vertically with respect to the rotation axis C on the lower side of the rotation part 20. The base plate 41 is a portion of the spindle motor 2 as well as a portion of the housing 40. The stator 12 and the bearing 13 are fixed to the base plate 41.

The stator 12 has a stator core 12a that is a magnetic body and multiple coils 12b. The stator core 12a has multiple teeth 12c protruding radially outward. The coils 12b are formed by conductive wires wound around the teeth 12c.

The bearing unit 13 rotatably supports a shaft 21 on the side of the rotation part 20. A fluid dynamic pressure bearing mechanism is used for the bearing unit 13, for example.

The rotation part 20 has the shaft 21, a hub 22, and a magnet 23. The shaft 21 is a columnar member extending in the axial direction. The lower end part of the shaft 21 is accommodated inside the bearing unit 13.

The hub 22 is fixed with the upper end part of the shaft 21 and spreads radially outward. The upper surface of an outer peripheral part 22a of the hub 22 supports the disk 50. The magnet 23 is fixed to the inner peripheral surface of the hub 22, and is disposed to face a radially outer side of the stator 12 at a predetermined distance. The magnet 23 is in a ring shape, and on the inner peripheral surface of the magnet 23, N and S poles are alternately magnetized in the peripheral direction.

When a drive current is supplied to the coils 12b, magnetic flux is generated in the teeth 12c. In addition, due to the interaction of the magnetic flux between the teeth 12c and the magnet 23, a torque in the peripheral direction is generated. As a result, the rotation part 20 rotates relative to the stationary part 10 with the rotation axis C as the center. Together with the rotation part 20, the disk 50 supported by the hub 22 rotates with the axis C as the center.

The disk 50 is an information recording medium in a disk shape having a hole at the central part. The respective disks 50 are mounted to the spindle motor 2 and are disposed in parallel with each other in the axial direction and at equal intervals via a spacer (not shown).

The head 31 magnetically performs information reading or information writing with respect to the disk 50. The arm 32 is installed to the tip end part of a pivot post 413 (to be described afterwards) of the base plate 41 via a bearing 32a. The head 31 is provided at the tip end part of the arm 32.

The swing mechanism 33 is a mechanism that swings the arm 32 and the head 31. When the swing mechanism 33 is driven, the arm 32 swings with a swing axis D as the center. That is, the head 31 swings with the swing axis D as the center by using the swing mechanism 33 via the arm 32. At this time, the head 31 moves relatively with respect to the disk 50, and approaches and accesses the rotating disk 50.

### 2. Detailed Configuration of the Base Plate

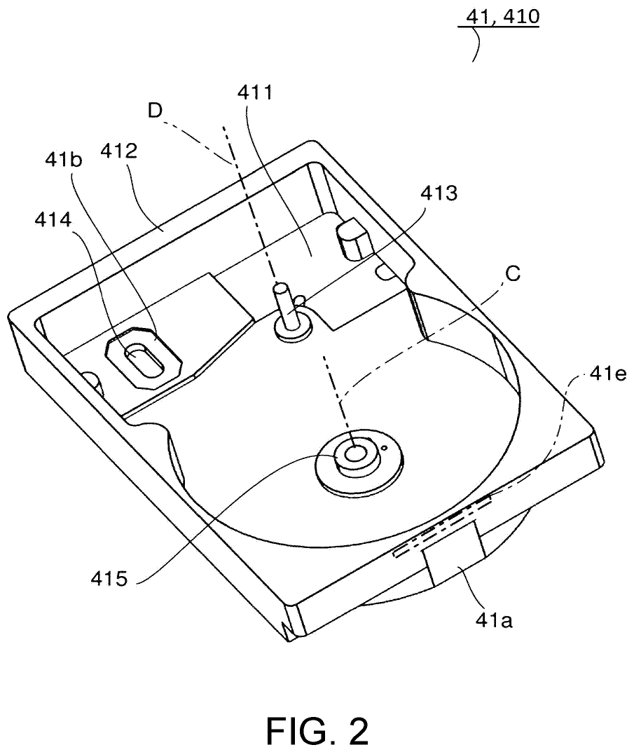

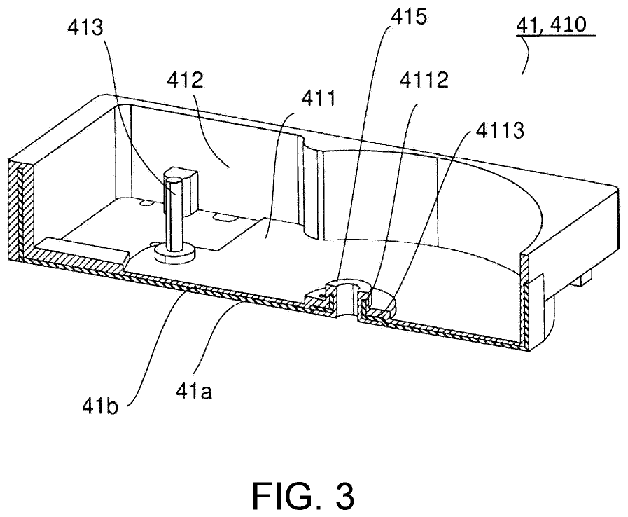

FIG. 2 is a perspective view of the base plate 41. FIG. 3 is a cross-sectional perspective view of the base plate 41. Regarding a gate mark part 41e shown in FIG. 2, while removed in a manufacturing process of the base plate 41 to be described afterwards, the mark is shown for the purpose of illustration.

The upper part of the base plate 41 is formed in a box shape with an opening, and the base plate 41 has a bottom wall part 411, a peripheral wall part 412, the pivot post 413, a connector window part 414, a cylindrical wall part 415. The bottom wall part 411 is in a rectangular shape when viewed in the axial direction, and spreads vertically with respect to the rotation axis C and the swing axis D.

The peripheral wall part 412 extends upward from the outer edge of the bottom wall part 411 and surrounds the periphery of the bottom wall part 411. The cover 42 (see FIG. 1) is disposed and, for example, screwed on the upper end surface of the peripheral wall part 412. In addition, the peripheral wall part 412 has the gate mark part 41e where a gate 214 (see FIG. 8) is connected at the time of casting. The gate mark part 41e is disposed on the outer surface of the peripheral wall part 412.

The pivot post 413 protrudes upward from the upper surface of the bottom wall part 411 along the swing axis D, and is formed in a cylindrically columnar shape. The connector window part 414 pulls out a connector (not shown) connected with the swing mechanism 33 to the outside of the base plate 41. The cylindrical wall part 415 is disposed on the rotation axis C and protrudes axially upward. The shaft 21 (see FIG. 1) is pressed into the cylindrical wall part 415. Accordingly, the base plate 41 and the shaft 21 are fixed.

The base plate 41 is formed by a metal plate 41a and a die-cast part 41b covering the metal plate 41a (see FIG. 3). The metal plate 41a is formed by pressing a metal plate, such as stainless steel, having a rigidity higher than aluminum alloy, for example. The die-cast part 41b is formed by a die-cast member, such as aluminum alloy. That is, the metal forming the metal plate 41a is higher in rigidity than the metal forming the die-cast part 41b. Accordingly, the strength of the base plate 41 can be prevented from being reduced, whereas the base plate 41 can be thinned. Thus, the housing 40 can be thinned in the axial direction. In addition, by thinning the base plate 41, the space in the axial direction inside the housing 40 can be spread. Accordingly, the disks 50 that can be accommodated in the housing 40 can increase.

The base plate 41 is an insert-cast product. The metal plate 41a and the die-cast part 41b are integrally formed. A method for manufacturing the base plate 41 can be described in detail afterwards.

### 3. Detailed Configuration of the Metal Plate

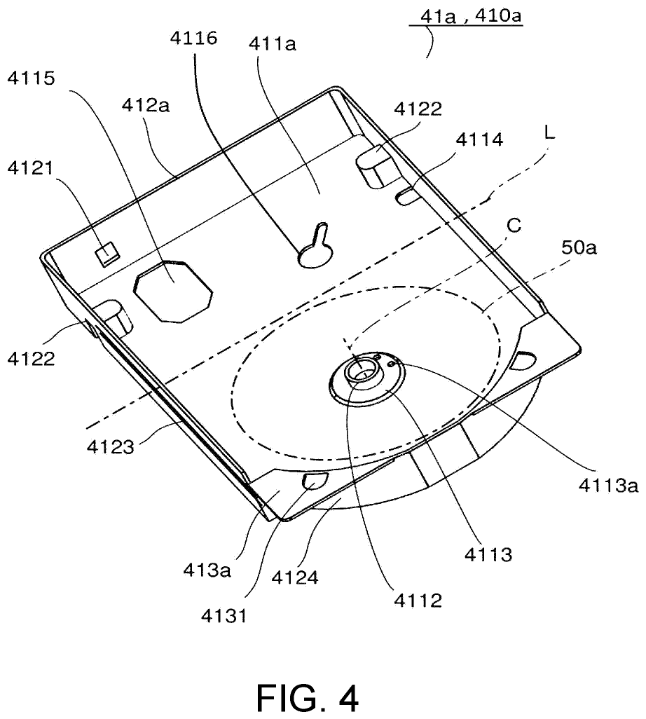

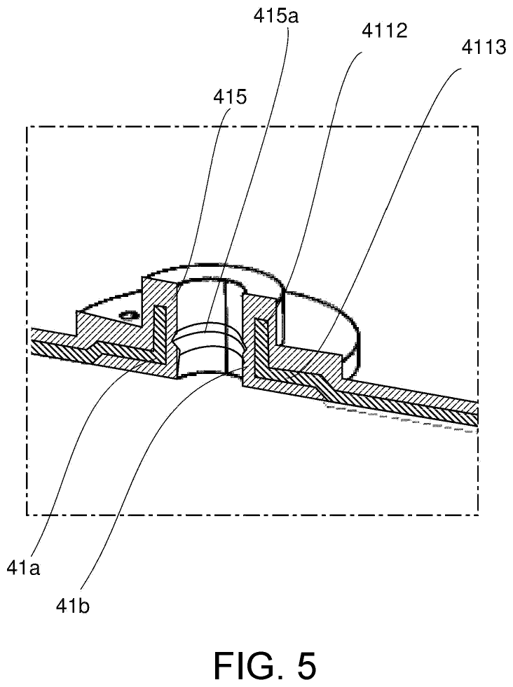

FIG. 4 is a perspective view of the metal plate 41a. FIG. 5 is an enlarged cross-sectional perspective view illustrating the cylindrical wall part 415 of the base plate 41.

The upper part of the metal plate 41a is formed in a box shape with an opening, and the metal plate 41a has a bottom plate part 411a, a peripheral plate part 412a, and a flange part 413a. The bottom plate part 411a is in a rectangular shape when viewed in the axial direction, and is formed in a plate shape that spreads vertically with respect to the rotation axis C. The peripheral plate part 412a extends upward from the outer edge of the bottom plate part 411a and surrounds the periphery of the bottom plate part 411a. The flange part 413a extends radially outward from the upper end of the peripheral plate part 412a surrounding the disk 50.

In the embodiment, the die-cast part 41b is bonded to the upper surface of the bottom plate part 411a to form the bottom wall part 411. In addition, the die-cast part 41b is bonded to the inner peripheral surface and the outer peripheral surface of the peripheral plate part 412a to form the peripheral wall part 412.

The bottom plate part 411a has a cylindrical part 4112, a stepped part 4113, multiple bottom plate through holes 4114, and a connector through hole 4115. The cylindrical part 4112 is disposed on the rotation axis C, penetrates axially, and protrudes axially upward. In the embodiment, the die-cast part 41b is bonded to the inner peripheral surface and the outer peripheral surface of the cylindrical part 4112 and the cylindrical wall part 415 is formed. That is, the inner peripheral surface of the cylindrical part 4112 is covered by the die-cast part 41b.

Since the shaft 21 is held by the cylindrical wall part 415 including the cylindrical part 4112 whose rigidity is higher than the metal forming the die-cast part 41b, the shaft 21 can be firmly fixed to the bottom plate part 411a. In addition, when the shaft 21 is pressed into the cylindrical part 4112, the die-cast part 41b covering the inner peripheral surface of the cylindrical part 4112 is deformed and serves as a buffer material. Accordingly, the stress concentration on the cylindrical part 4112 is reduced, and the deformation of the cylindrical part 4112 can be avoided.

In addition, a groove part 415a extending in the peripheral direction is formed on the inner peripheral surface of the die-cast part 41b disposed on the inner peripheral surface of the cylindrical part 4112. By forming the groove part 415a, the die-cast part 41b covering the inner peripheral surface of the cylindrical part 4112 deforms more easily. Accordingly, the press-in force of the shaft 21 is reduced, and the concentrated stress on the cylindrical part 4112 can be further reduced. In addition, in the case where an adhesive is coated on the outer peripheral surface of the lower end part of the shaft 21 and pressed into the cylindrical part 4112, the adhesive is collected inside the groove part 415a, and the shaft 21 can be more firmly fixed by the cylindrical part 4112.

The stepped part 4113 is formed in an annular shape protruding axially upward to surround the cylindrical part 4112. By providing the stepped part 4113, the die-cast part 41b bonded to the lower surface of the stepped part 4113 can be formed with a great thickness. In addition, by bending the bottom plate part 411a to form the stepped part 4113, the strength of the stepped part 4113 can be increased. Accordingly, the rigidity at the root part of the cylindrical part 4112 can be increased. In addition, the stepped part 4113 has multiple conductive wire through holes 4113 penetrating axially and arranged in the peripheral direction. The die-cast part 41b is not filled into the conductive wire through holes 4113a. The conductive wire through holes 4113a extend axially and penetrates through the die-cast part 41b. Accordingly, the conductive wires (not shown) connected with the spindle motor 2 can be drawn to the outside of the press plate 41 via the conductive wire through holes 4113a.

The bottom plate through holes 4114 axially penetrate through the bottom plate part 411a, and the die-cast part 41b is filled into the bottom plate through holes 4114. By providing the bottom plate through holes 4114, the bonding strength between the die-cast part 41b and the bottom plate part 411a is increased. In addition, the number of the bottom plate through holes 4114 disposed on the inner side of a disk facing region 50a formed on the bottom plate part 411a by projecting the disk 50 in the axial direction is fewer than the number of the bottom plate through holes 4114 disposed on the outer side of the disk facing region 50a. In the embodiment, the bottom plate through holes 4114 are not provided on the inner side of the disk facing region 50a.

By reducing the bottom plate through holes 4114 provided in the disk facing region 50a, the variation of the axial thickness of the die-cast part 41b in the disk facing region 50a is reduced and the thickness of the die-cast part 41b can be formed uniformly. Accordingly, the concern that the disks 50 inside the housing 40 contact the upper surface of the die-cast part 41b can be alleviated.

The connector through hole 4115 axially penetrates through the bottom plate part 411a and allows the connector (not shown) connected with the swing mechanism 33 to be drawn out. A portion of the connector through hole 4115 is covered by the die-cast part 41b, and a connector window part 414 is formed (see FIG. 2). By performing cutting machining on the die-cast part 41b covering a portion of the connector through hole 4115, the opening area of the connector through hole 4115 (the diameter of the connector window part 414) can be changed easily.

The peripheral plate part 412a has a peripheral plate through hole 4121, concave parts 4122, a peripheral plate groove part 4123. The peripheral plate through hole 4121 radially penetrates through the peripheral plate part 412a, and the die-cast part 41b is filled into the peripheral plate through hole 4121. By providing the peripheral plate through hole 4121, the bonding strength between the die-cast part 41b and the peripheral plate part 412a is increased.

The concave part 4122 is formed so that a portion of the bottom plate part 411a and the peripheral plate part 412a is recessed inwardly across the boundary between the bottom plate part 411a and the peripheral plate part 412a. The die-cast part 41b is filled into the bottom plate 4122. In addition, the concave part 4122 is disposed on the side opposite to the central axis C by sandwiching a central line L extending in the transverse direction through the center of the bottom plate part 411a in the longitudinal direction. By providing the concave part 4122, the bonding strength between the die-cast part 41b and the peripheral plate part 412a is increased. In addition, the concave part 4122 is disposed on the side opposite to the central axis C by sandwiching the central line L. Accordingly, the concave part 4122 can be prevented from contacting the disk 50.

The peripheral plate groove part 4123 is formed on the bonding surface with the die-cast part 41b. In the embodiment, the peripheral plate groove part 4123 is formed on the outer peripheral surface of the peripheral plate part 412a and extends in the peripheral direction. By providing the groove part 4123, the bonding strength between the die-cast part 41b and the peripheral plate part 412a is increased. The groove part 4123 may also be formed on the inner peripheral surface of the peripheral plate part 412a.

The flange part 413a extends radially outward from the upper end of a curved part 4124 of the peripheral plate part 412a, and at least a portion is covered by the die-cast part 41b. The curved part 4124 is curved along the edge of the disk 50 when viewed in the axial direction. The flange part 413a has a flange through hole 4131. The flange through hole 4131 penetrates axially, and the die-cast part 41b is filled into the flange through hole 4131. By providing the flange through hole 4131, the bonding strength between the die-cast part 41b and the flange part 413a is increased.

### 4. Method for Manufacturing a Base Plate

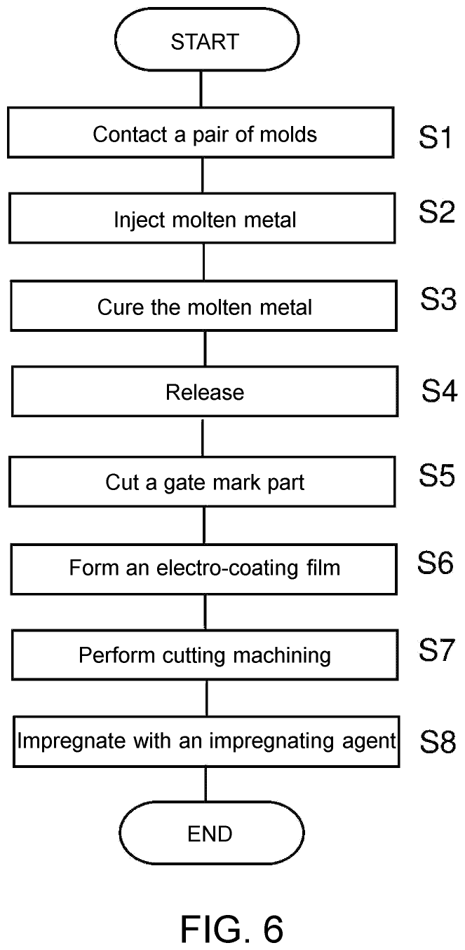

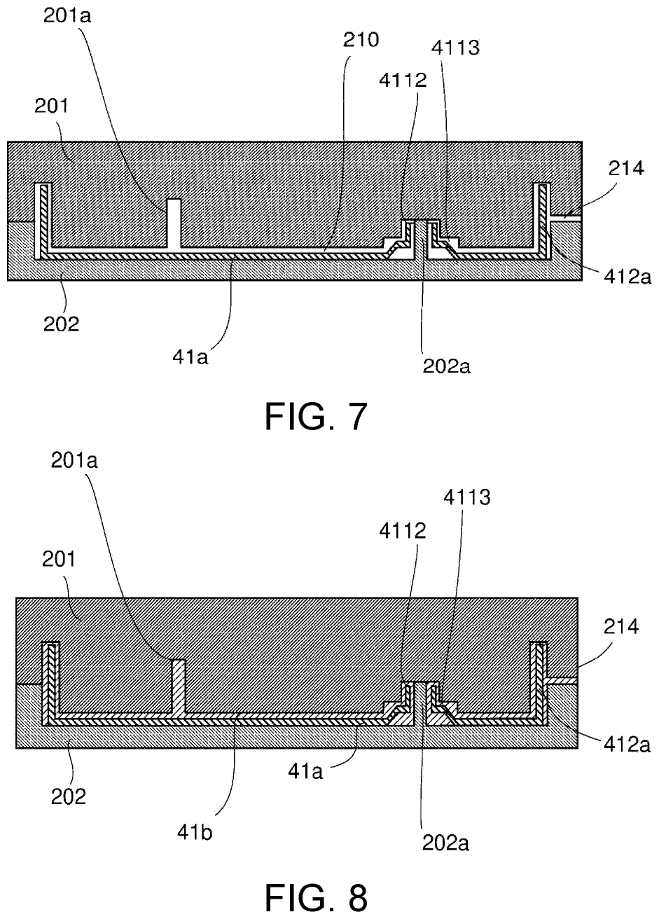

FIG. 6 is a flowchart illustrating a manufacturing process of the base plate 41. FIGS. 7 to 13 are views illustrating the manufacturing process of the base plate according to the invention.

In Step S1, as shown in FIG. 7, the edge part of a mold 202 where the metal plate 41a is held and the edge part of a mold 201 are brought into contact in the upper-lower direction to form a cavity 210 between the mold 201 and the mold 202. The cavity 210 has a shape corresponding to the shape of the die-cast part 41b. In addition, the cavity 210 is in communication with a gate 214 extending along the facing surfaces of the mold 201 and the mold 202. The outer end part of the gate 214 is open to the outside of the mold 201 and the mold 202.

In addition, an air venting path (not shown) for ventilating air inside the cavity 210 is provided, in addition to the gate 214, on the facing surfaces of the molds 201 and 202. The outer end part of the air venting flow path is open to the outside of the molds 201 and 202.

The mold 201 has a column-like concave part 201a. The column-like concave part 201a is formed, so that the lower surface of the mold 201 is recessed axially upward. The inside of the column-like concave part 201a is in communication with the cavity 210. Molten metal flows into the column-like concave part 201a to form a pivot post 413.

The mold 202 has a column part 202a. The column part 202a protrudes axially upward from the upper surface and is inserted into the cylindrical part 4112. At this time, a gap between the inner peripheral surface of the cylindrical part 4112 and the outer peripheral surface of the column part 202a is in communication with the cavity 210.

In Step S2, as shown in FIG. 8, molten metal is injected into the cavity 210 via the gate 214. The molten metal is, for example, molten aluminum alloy. When the molten metal is injected into the cavity 210, the air inside the cavity 210 or the gas generated from the molten metal is pushed out of the molds 201 and 202 from the air venting flow path. Accordingly, the molten metal spreads through the entire cavity 210.

At this time, the molten metal flows into the gap between the inner peripheral surface of the cylindrical part 412 and the outer peripheral surface of the column part 202a, and the inner peripheral surface of the cylindrical part 4112 is covered by the die-cast part 41b. In addition, the molten metal flows into the bottom plate through holes 4114 and the connector through hole 4115 of the bottom plate part 411a, the peripheral plate through hole 4121 and the concave part 4122 of the peripheral plate part 412a.

In Step S3, after the molten metal spreads through the cavity 210, the molten metal is cooled and cured. Accordingly, the base plate 41 is formed inside the cavity 210. A chill layer (not shown) is formed on the surface of the base plate 41. The chill layer is formed at a place where, at the time of being cured, the molten metal contacts the molds 201 and 202 and is cured early. The chill layer where the molten metal is cured earlier than other portions has fewer impurities and a high metal density.

By injecting molten metal into the molds 201, 202 where the metal plate 41a is placed, the die-cast part 41b covering the metal plate 41a is cast and formed. Therefore, it is possible to easily form the base plate 41 in a complicated shape, whose strength is reinforced by the metal plate 41 in a simple shape.

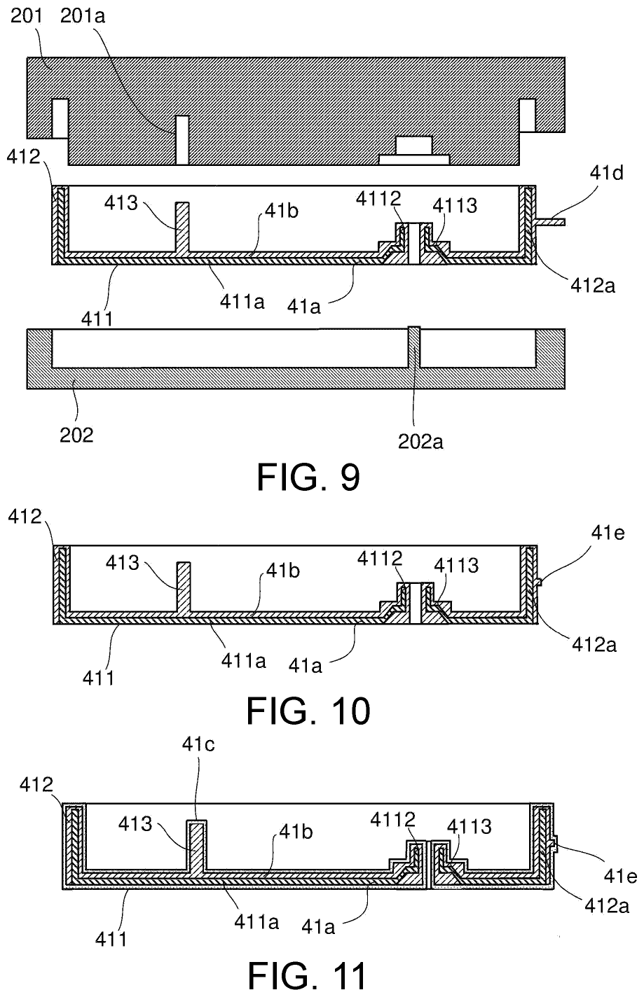

In Step 4, as shown in FIG. 9, the base plate 41 is released from the pair of molds 201, 202. At this time, the peripheral wall part 412 has a gate mark part 41d protruding from the outer surface. The gate mark part 41d is formed by curing the molten metal collected in the gate 214 and the air venting flow path (not shown).

In Step S5, as shown in FIG. 10, the gate mark part 41d is cut off. A gate mark part 41e where the gate mark part 41d is cut off slightly protrudes from the outer surface of the peripheral wall part 412 to leave a mark.

In Step S6, as shown in FIG. 11, an electro-coating film 41c is formed on the surface of the die-cast part 41b. For the electro-coating film 41c, for example, the base plate 41 is immersed into a coating material of an epoxy-based resin, and a current flows through between the coating material and the die-cast part 41b. Accordingly, the coating material is attached to the die-cast part 41b and the surface of the metal plate 41a that is exposed, and the electro-coating film 41c is formed. At this time, the outer surface of the gate mark part 41e is also covered by the electro-coating film 41c. By covering the die-cast part 41b and at least a portion of the surface of the exposed metal plate 41a by using the electro-coating film 41c, the insulating property of the base plate 41 is increased, and gas leakage through the base plate 41 can be reduced.

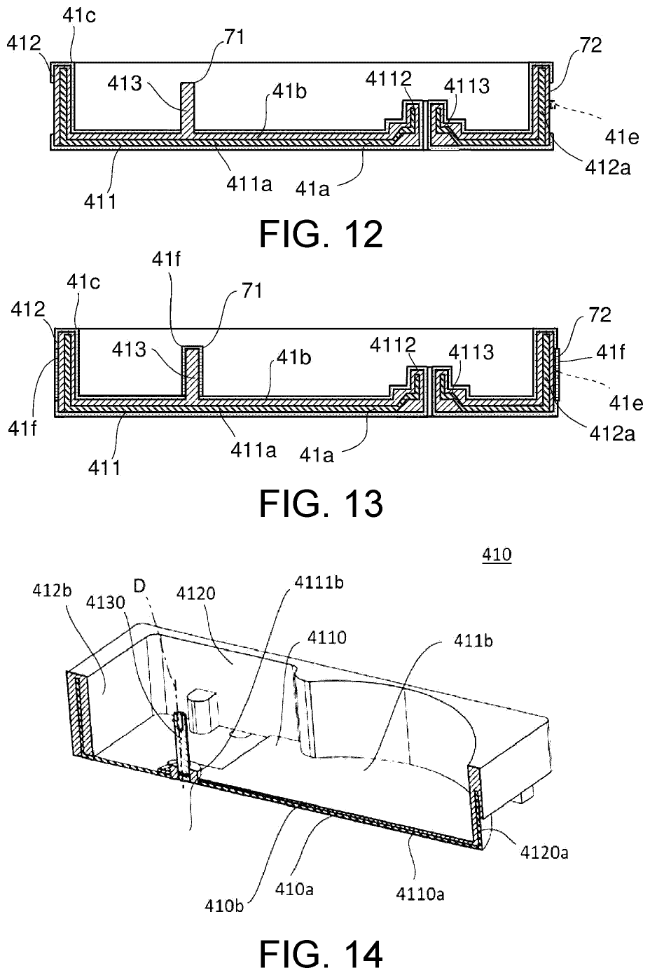

In Step S7, as shown in FIG. 12, on the surface of the die-cast part 41b, the pivot post 413 which requires precision is precisely machined and shaped by cutting.

At this time, by cutting the surface of the base plate 41, the electro-coating film 41c is also cut, and a machined surface 71 is formed. Accordingly, on the peripheral surface of the pivot post 413, a region where the electro-coating film 41c is not provided is formed.

In addition, in Step S7, the outer surface of the die-cast part 41b of the peripheral wall part 412 including the gate mark part 41e formed when the gate mark part 41d is removed in Step S5 is cut and shaped. At this time, the electro-coating film 41c of the outer peripheral surface of the peripheral wall part 412 is cut, and a machined surface 72 is formed. That is, the machined surface 72 obtained by performing cutting machining on the surface of the die-cast part 41b is formed to include at least a portion of the gate mark part 41e. Accordingly, the gate mark part 41e formed through collection at the gate 214 and the air venting flow path (not shown) can be shaped through a series of processes.

The machined surface 72 may also be formed only on a surface including the gate mark part 41e of the peripheral wall part 412. In addition, the machined surface 72 may also be formed across the surface of the peripheral wall part 412 including the gate mark part 41e and at least one surface adjacent to such surface.

In addition, in Step S7, although the mark is no longer present after being removed through cutting, the gate mark part 41e is shown in a broken line in FIG. 12 to illustrate the mark where the gate is connected at the time of casting.

In Step S8, the base plate 41 is immersed into an impregnating agent. At this time, as shown in FIG. 13, the machined surfaces 71 and 72 where the electro-coating film 41c is cut are impregnated with the impregnating agent 41f. The impregnating agent 41f is, for example, an epoxy resin or an acrylic resin. Accordingly, on the machined surfaces 71, 72 where the electro-coating film 41c is cut, fine cavities formed on the surface of the die-cast part 41b are sealed by the impregnating agent 41f. Accordingly, the helium gas filled into the housing 40 can be prevented from being leaked to the outside via the machined surface 72.

It is noted that the impregnating agent 41f is less viscous than the coating material for forming the electro-coating film 41c. Therefore, compared with the coating material forming the electro-coating film 41c, it is easy for the impregnating agent 41f to impregnate the fine cavities formed on the surface of the die-cast part 41b.

According to the above, the method for manufacturing the base plate 41 as a cast product that forms a portion of the housing 40 of the disk drive device 1 sequentially includes a casting process, a removal process, an electro-coating process, a cutting process, an impregnating process. In the casting process, the metal plate 41a and the die-cast part 41b are cast integrally by using the molds (Step S1 to S4). In the removal process, the gate mark part 41d is cut (Step S5). In the electro-coating process, the electro-coating film 41c is formed at least on the die-cast part 41b and a portion of the metal plate 41a that is exposed (Step S6). In the cutting process, the surface of the base plate 41 is cut and shaped (Step S7). In the impregnating process, on the surface of the die-cast part 41b, the machined surface exposed from the electro-coating film 41c is impregnated with the impregnating agent.

### 5. Others

The above embodiment merely serves as an example of the invention. The configuration of the embodiment may be modified as appropriate without departing from the technical idea of the invention. Further, the embodiments may be implemented in combination to the extent possible. For example, in the embodiment, the die-cast part 41b is bonded to the upper surface of the bottom plate part 411a to form the bottom wall part 411. However, it may also be that the die-cast part 41b is bonded to the upper surface and the lower surface of the bottom plate part 411a to form the bottom wall part 41b.

Exemplary embodiments of the second invention will be described below with reference to the drawings.

### 6. Detailed Configuration of the Metal Plate

FIG. 4 is a perspective view of the metal plate 41a. The upper part of the metal plate 41a is formed in a box shape with an opening, and the metal plate 41a has the bottom plate part 411a and the peripheral plate part 412a. The bottom plate part 411a is in a rectangular shape when viewed in the axial direction, and is formed in a plate shape that spreads vertically with respect to the rotation axis C. The peripheral plate part 412a extends upward from the outer edge of the bottom plate part 411a and surrounds the periphery of the bottom plate part 411a.

The bottom plate part 411a has the cylindrical part 4112 and a pivot through hole 4116. The cylindrical part 4112 is disposed on the rotation axis C, penetrates axially, and protrudes axially upward. In the embodiment, the die-cast part 41b is bonded to the inner peripheral surface and the outer peripheral surface of the cylindrical part 4112 and the cylindrical wall part 415 is formed.

Since the shaft 21 is held by the cylindrical wall part 415 including the cylindrical part 4112 whose rigidity is higher than the metal forming the die-cast part 41b, the shaft 21 can be firmly fixed to the bottom plate part 411a. In addition, when the shaft 21 is pressed into the cylindrical part 4112, the die-cast part 41b covering the inner peripheral surface of the cylindrical part 4112 is deformed and serves as a buffer material. Accordingly, the stress concentration on the cylindrical part 4112 is reduced, and the deformation of the cylindrical part 4112 can be avoided.

The pivot through hole 4116 is disposed on the swing axis D and axially penetrates through the bottom plate part 411, and the die-cast part 41b is filled into the pivot through hole 4116. In addition, a pivot post 413 is disposed on the pivot through hole 4116.

### 7. Detailed Configuration of the Die-Cast Part

FIG. 14 is a cross-sectional perspective view of a base plate 410. A die-cast part 410b is bonded to a metal plate 410a, and has a bottom surface part 411b and a peripheral surface part 412b. The bottom surface part 411b is bonded to the upper surface of a bottom plate part 4110a and spreads vertically with respect to the rotation axis C. In the embodiment, a bottom wall part 4110 is formed by the bottom plate part 4110a and the bottom surface part 411b.

The bottom surface part 411b has a pedestal part 4111b on the pivot through hole 4116 of the metal plate 410a. The pedestal part 4111b protrudes upward from the upper surface of the bottom surface part 411b along the swing axis D, and is formed in a cylindrical shape. The lower end part of the pivot post 4130 is disposed inside the pedestal part 4111b. The pivot post 4130 is held inside the pedestal part 4111b and firmly fixed to the bottom surface part 411b.

The peripheral surface part 412b is bonded to the outer peripheral surface and the inner peripheral surface of a peripheral plate part 4120a. The peripheral surface part 412b bonded to the inner peripheral surface of the peripheral plate part 4120a extends upward from the outer edge of the bottom surface part 411b to surround the periphery of the bottom surface part 411b. In the embodiment, a peripheral wall part 4120 is formed by the peripheral plate part 4120a and the peripheral surface part 412b.

### 8. Detailed Configuration of the Pivot Post

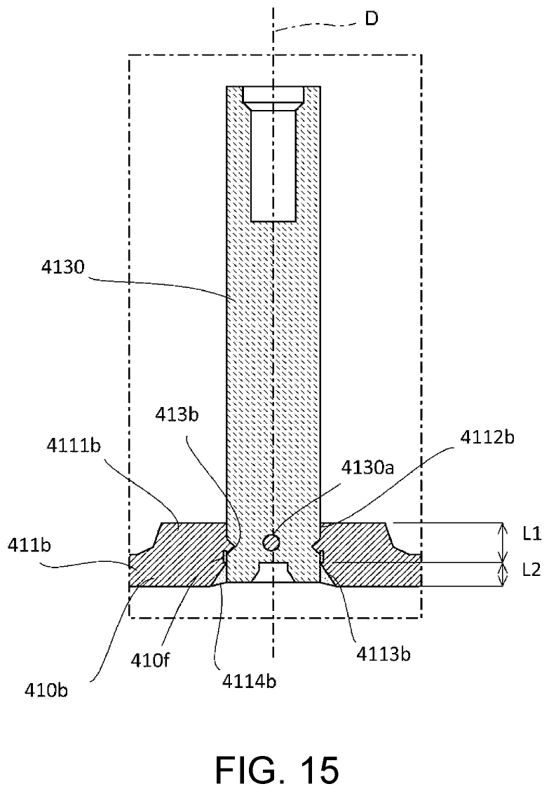

FIG. 15 is an enlarged front cross-sectional view illustrating the pivot post 4130. The pivot post 4130, for example, may be formed by metal with rigidity higher than aluminum alloy, such as stainless steel, and is formed in a columnar shape.

The pivot post 4130 is a separate member from the die-cast part 410. The metal forming the pivot post 4130 is more rigid than the metal forming the die cast part 104b. Accordingly, the rigidity of the pivot post 4130 is increased, and shrinkage cavities may not occur in the pivot post 4130 due to insert casting. Accordingly, the gas filled into the housing 40 can be prevented from leaking to the outside via the pivot post 4130.

The pivot post 4130 has a pivot through hole 4130a and a pivot groove part 413b. The pivot through hole 4130a is provided inside the pedestal part 4111b, and penetrates through the pivot post 4130 in the radial direction of the swing axis D. The die-cast part 410b is filled into the post through hole 4130a. Accordingly, the pivot post 4130 is more firmly held inside the pedestal part 4111b.

In addition, the post groove part 413b is disposed inside the pedestal part 4111b, and is recessed on the radially inner side of the swing axis D to extend in the peripheral direction. The die-cast part 410b is filled into the post groove part 413b. Accordingly, the bonding strength between the pedestal part 4111b and the pivot post 4130 is increased. Accordingly, the pivot post 4130 is more firmly held inside the pedestal part 4111b.

The surface roughness of the outer peripheral surface of the pivot post 4130 inside the pedestal part 4111b is greater than the surface roughness of the pivot post 4130 outside the pedestal part 4111b. Accordingly, the bonding strength between the pedestal part 4111b and the pivot post 4130 is further increased.

On the periphery of the pivot post 4130, the bottom surface part 411b of the die-cast part 410b has a bonding part 4112b and an inclined part 4113b. The bonding part 4112b is bonded to the pivot post 4130, and at least a portion of the bonding part 4112b is impregnated with an impregnating agent 410f. Accordingly, the gas filled into the housing 40 can be prevented from leaking to the outside via the bonding part 4112b.

The inclined part 4113b is inclined in a direction away from the pivot post 4130 from the lower end of the bonding part 4112b toward the axially lower side. By providing the inclined part 4113b, it becomes easy to impregnate the bonding part 4112b with the impregnating agent 410f from the lower surface side of the bottom surface part 411b. At this time, a length L1 of the bonding part 4112b in the axial direction is longer than a length L2 of the inclined part 4113b in the axial direction. Accordingly, in the case where the inclined part 4113b is provided, the bonding strength between the pedestal part 4111b and the pivot post 4130 is prevented from increasing.

In addition, a sealing member 4114b is disposed at a gap between the inclined part 4113b and the pivot post 4130. Accordingly, the gas filled into the housing 40 can be further prevented from leaking to the outside via the bonding part 4112b. As the sealing member, an epoxy-based thermosetting adhesive may be used as appropriate.

### 9. Method for Manufacturing a Base Plate

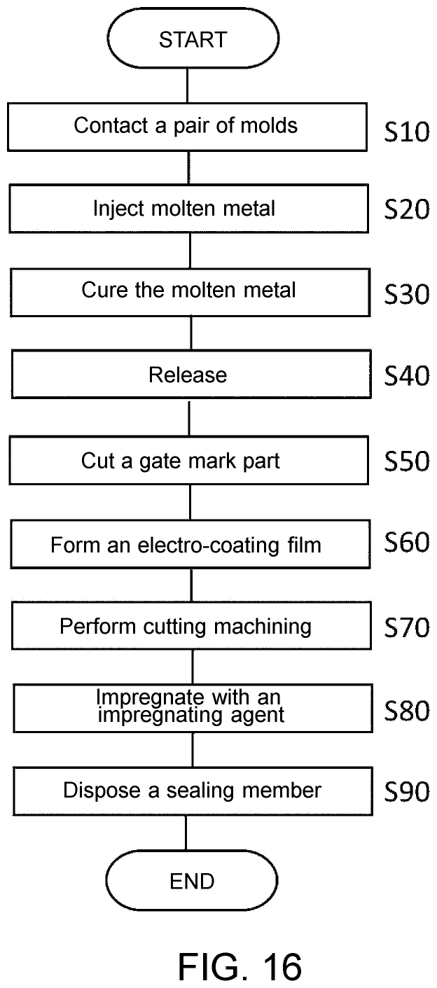

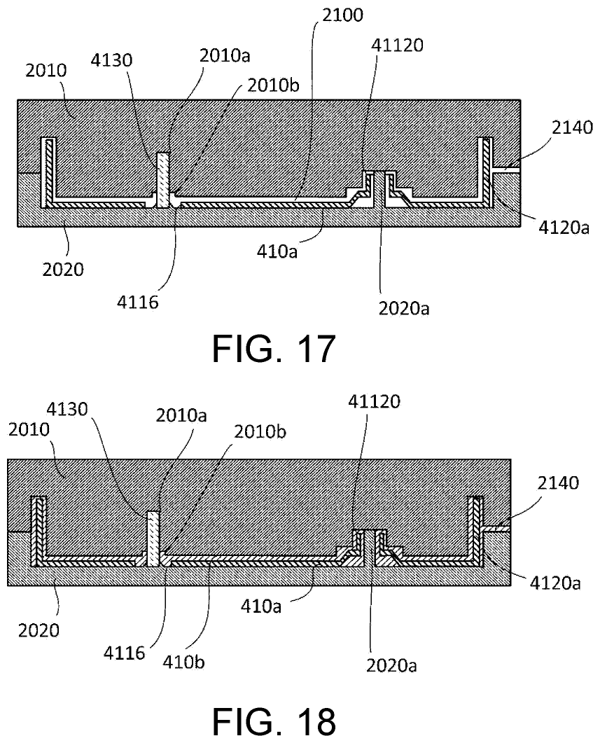

FIG. 16 is a flowchart illustrating a manufacturing process of the base plate 410. FIGS. 17 to 23 are views illustrating the manufacturing process of the base plate according to the invention.

In Step S10, as shown in FIG. 17, the edge part of a mold 2020 where the metal plate 410a is held and the edge part of a mold 2010 where the pivot post 4130 is held are brought into contact in the upper-lower direction. Accordingly, a cavity 2100 is formed between the molds 2010 and 2020. The cavity 2100 has a shape corresponding to the shape of the die-cast part. In addition, the cavity 2100 is in communication with a gate 2140 extending along the facing surfaces of the mold 2010 and the mold 2020. The outer end part of the gate 2140 is open to the outside of the mold 2010 and the mold 2020.

In addition, an air venting path (not shown) for ventilating air inside the cavity 2100 is provided, in addition to the gate 2140, on the facing surfaces of the molds 2010 and 2020. The outer end part of the air venting flow path is open to the outside of the molds 2010 and 2020.

The mold 2010 has a column-like concave part 2010a and a pedestal concave part 2010b. In the column-like concave part 2010a, the lower surface of the mold 2010 is recessed toward the axially upper side. The pivot post 4130 is disposed inside the column-like concave part 2010a. The pedestal concave part 201b surrounds the column-like concave part 2010a, and the lower surface of the mold 2010 is formed with a recess toward the axially upper side. The pedestal concave part 201b is in communication with the cavity 2100.

The mold 2020 has a column part 2020a. The column part 2020a protrudes axially upward from the upper surface and is inserted into the cylindrical part 4112. At this time, a gap between the inner peripheral surface of the cylindrical part 41120 and the outer peripheral surface of the column part 2020a is in communication with the cavity 2100.

In Step S20, as shown in FIG. 18, molten metal is injected into the cavity 2100 via the gate 2140. The molten metal is, for example, molten aluminum alloy. When the molten metal is injected into the cavity 2100, the air inside the cavity 2100 or the gas generated from the molten metal is pushed out of the molds 2010 and 2020 from the air venting flow path. Accordingly, the molten metal spreads through the entire cavity 2100.

At this time, the molten metal flows into the pedestal concave part 201b and the pedestal part 4111b is formed. In addition, the molten metal flows into the pivot through hole 4116 and contacts the lower end of the pivot post 4130. Moreover, the molten metal flows into the gap between the inner peripheral surface of the cylindrical part 41120 and the outer peripheral part of the column part 2020a, and the inner peripheral surface of the cylindrical part 41120 is covered by the die-cast part 410b. At this time, the molten metal flows into the post through hole 4130a and the post groove part 413b.

In Step S30, after the molten metal spreads through the cavity 2100, the molten metal is cooled and cured. Accordingly, the base plate 410 is formed inside the cavity 2100. A chill layer (not shown) is formed on the surface of the base plate 410. The chill layer is formed at a place where, at the time of being cured, the molten metal contacts the molds 2010 and 2020 and is cured early. The chill layer where the molten metal is cured earlier than other portions has fewer impurities and a high metal density.

By injecting molten metal into the molds 2010, 2020 where the metal plate 410a is placed, the die-cast part 410b covering the metal plate 410a is cast and formed. Therefore, it is possible to easily form the base plate 410 in a complicated shape, whose strength is reinforced by the metal plate 410a in a simple shape.

At this time, the bottom surface part 411b is formed on the upper surface of the metal plate 410a. In addition, the pedestal part 4111b is formed on the pivot through hole 4116. The lower end part of the pivot post 4130 is held inside the pedestal part 4111b.

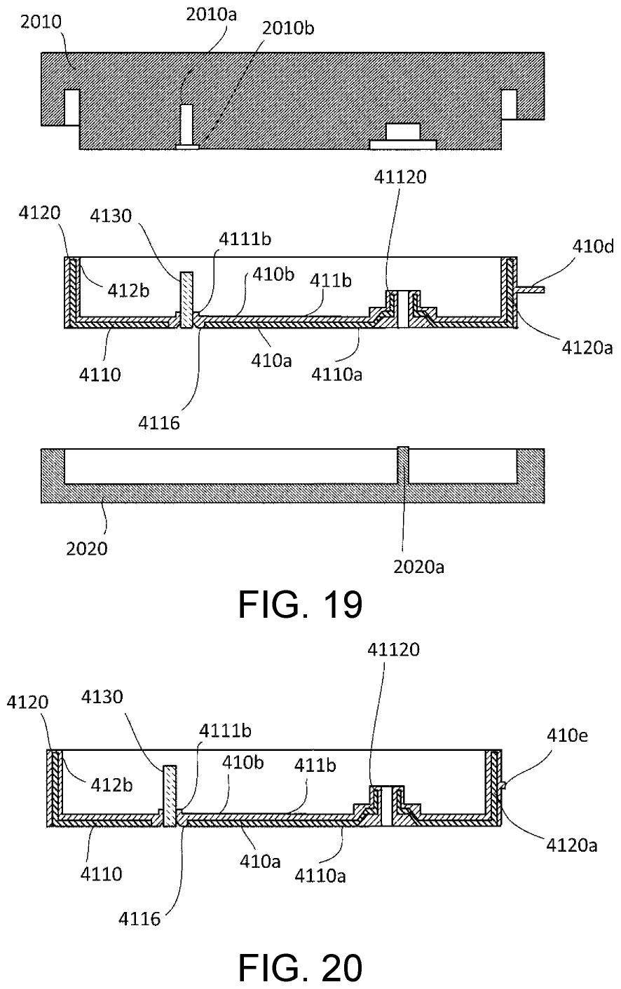

In Step 40, as shown in FIG. 19, the base plate 410 is released from the pair of molds 2010, 2020. At this time, the peripheral wall part 4120 has a gate mark part 410d from the outer surface. The gate mark part 410d is formed by curing the molten metal collected in the gate 2140 and the air venting flow path (not shown).

In Step S50, as shown in FIG. 20, the gate mark part 410d is cut off. A gate mark part 410e where the gate mark part 410d is cut off slightly protrudes from the outer surface of the peripheral wall part 4120 to leave a mark.

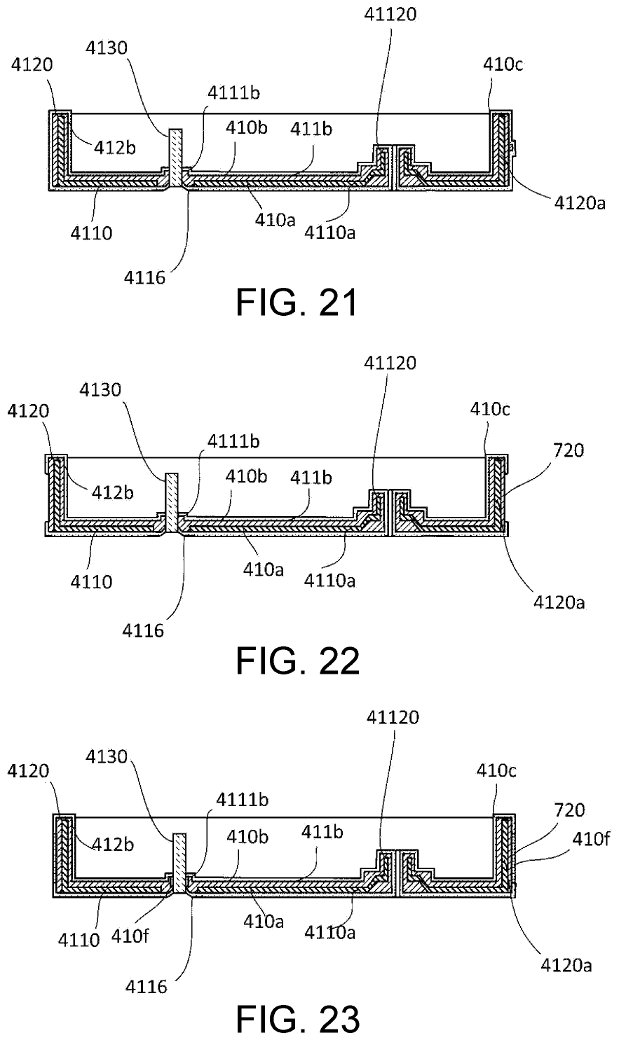

In Step S60, as shown in FIG. 21, an electro-coating film 410c is formed on the surface of the die-cast part 410b. For the electro-coating film 410c, for example, the base plate 410 is immersed into a coating material of an epoxy-based resin, and a current flows through between the coating material and the die-cast part 410b. Accordingly, the coating material is attached to the die-cast part 410b, and the electro-coating film 410c is formed. At this time, the outer surface of the gate mark part 410e is also covered by the electro-coating film 410c. By covering at least a portion of the surface of the die-cast part 410b by using the electro-coating film 410c, the insulating property of the base plate 410 is increased, and gas leakage through the base plate 410 can be reduced.

In Step S70, as shown in FIG. 22, on the surface of the die-cast part 410b, a portion which requires precision is precisely machined and shaped by cutting. In addition, in Step S70, the outer surface of the die-cast part 410b of the peripheral wall part 4120 including the gate mark part 410e formed when the gate mark part 410d is removed in Step S50 is cut and shaped.

At this time, the electro-coating film 410c of the outer peripheral surface of the peripheral wall part 4120 is cut, and a machined surface 720 is formed. Accordingly, through a series of processes, the gate mark part 410e and the overflow formed through collection at the gate 2140 and the air venting flow path (not shown) can be shaped.

The machined surface 720 may also be formed only on a surface including the gate mark part 410e of the peripheral wall part 4120. In addition, the machined surface 720 may also be formed across a surface including the gate mark part 410e of the peripheral wall part 4120 and at least one surface adjacent to such surface.

In Step S80, the base plate 410 is immersed into an impregnating agent. At this time, as shown in FIG. 23, the machined surface 720 where the electro-coating film 410c is cut is impregnated with the impregnating agent 410f. In addition, the bonding part 4112b bonded to the pivot post 4130 of the die-cast part 410b is impregnated with the impregnating agent 410f (see FIG. 15). The impregnating agent 410f is, for example, an epoxy resin or an acrylic resin. Accordingly, on the machined surface 720 where the electro-coating film 410c is cut, fine cavities formed on the surface of the die-cast part 410b are sealed by the impregnating agent 410f. Accordingly, the gas filled into the housing 40 can be prevented from being leaked to the outside via the machined surface 720.

It is noted that the impregnating agent 410f is less viscous than the coating material for forming the electro-coating film 410c. Therefore, compared with the coating material forming the electro-coating film 410c, it is easy for the impregnating agent 410f to impregnate the fine cavities formed on the surface of the die-cast part 410b.

In Step S90, the sealing member 4114b is disposed at a gap between the inclined part 4113b and the pivot post 4130.

According to the above, the method for manufacturing the base plate 410 as a cast product that forms a portion of the housing 40 of the disk drive device 100 sequentially includes a casting process, a removal process, an electro-coating process, a cutting process, an impregnating process, a sealing process.

In the casting process, the pivot post 4130 is placed in the mold 2010 and the molten metal is injected, and the die-cast part 410b having the bottom surface part 411b is formed. Accordingly, the die-cast part 410b having the bottom surface part 411b and the pivot post 4130 formed as a separate member from the die-cast part 410b are cast integrally by using a mold (Steps S10 to S40). In the removal process, the gate mark part 410d is cut (Step S50).

In the electro-coating process, the electro-coating film 410c is formed on the surface of the die-cast part 410b (Step S60). In the cutting process, the surface of the base plate 410 is cut and shaped (Step S70).

In the impregnating process, on the surface of the die-cast part 410b, the machined surface 720 exposed from the electro-coating film 410c and the bonding part 4112b bonded to the pivot post 4130 of the die-cast part 410b (see FIG. 15) are impregnated with the impregnating agent (Step S80)

In the sealing process, the sealing member 4114b is disposed at a gap between the inclined part 4113b and the pivot post 4130 (Step S90).

### 10. Others

The above embodiment merely serves as an example of the invention. The configuration of the embodiment may be modified as appropriate without departing from the technical idea of the invention. Further, the embodiments may be implemented in combination to the extent possible. For example, any of the pedestal part 4111b, the post through hole 4130a, the post groove part 413b, the inclined part 4113b, the sealing member 4114b, and the impregnating agent 410f may be omitted.

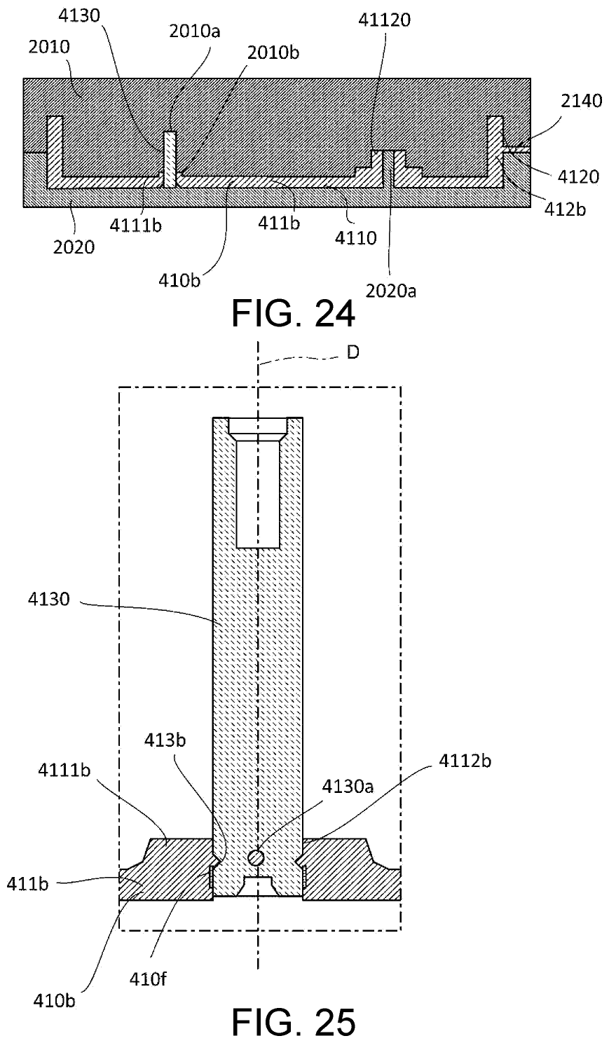

In addition, FIG. 24 is a schematic view illustrating a manufacturing process of the base plate 410 according to a modified example. The base plate 410 may be formed by omitting the metal plate 410a. At this time, the die-cast part 410b and the pivot post 4130 are integrally formed. In addition, the bottom wall part 4110 is formed by the bottom surface part 411b. The peripheral wall part 4120 is formed by the peripheral surface part 412b.

FIG. 25 is an enlarged front cross-sectional view illustrating the pivot post 4130, and the inclined part 4113b is not formed. Accordingly, the area of the bonding part 4112b increases, and the bonding strength between the pedestal part 4111b and the pivot post 4130 is further increased. In addition, in the case where the inclined part 4113b is not formed, the sealing process (Step S90) in the manufacturing process of the base plate 410 is also omitted. In addition, at least a portion of the bonding part 4112b is impregnated with the impregnating agent 410f.

### 11. Summary

The second invention is configured as follows.

(1) A base plate is configured as a portion of a housing of a disk drive device. The base plate includes: a die-cast part, having a bottom surface part spreading vertically with respect to a rotation axis of a disk extending in an upper-lower direction; and a pivot post, disposed at a position different from the rotation axis, and protruding upward from an upper surface of the bottom surface part along a swing axis of a head performing information reading or information writing with respect to a disk, the pivot post extending in an upper-lower direction. The pivot post is a separate member from the die-cast part. The metal forming the pivot post is more rigid than the metal forming the die cast part.
(2) In the base plate according to (1), the bottom surface part has a cylindrical pedestal part protruding upward from an upper surface along the swing axis, and a lower end part of the pivot post is disposed inside the pedestal part.
(3) In the base plate according to (2), a surface roughness of an outer peripheral surface of the pivot post inside the pedestal part is greater than a surface roughness of the outer peripheral surface of the pivot post outside the pedestal part.
(4) In the base plate according to (2) or (3), the pivot post has, on a peripheral surface, a post groove part recessed on a radially inner side of the swing axis to extend in a peripheral direction, the post groove part is disposed inside the pedestal part, and the die-cast part is filled therein.
(5) In the base plate according to any one of (2) to (4), the pivot post has a post through hole penetrating in a radial direction of the swing axis, the post through hole is disposed inside the pedestal part, and the die-cast part is filled therein.
(6) In the base plate according to any one of (1) or (5), the base surface part has a bonding part bonded to the pivot post, and at least a portion of the bonding part is impregnated with an impregnating agent.
(7) In the base plate according to any one of (1) or (5), the bottom surface part has: a bonding part, bonded to the pivot post; and an inclined part, inclined in a direction away from the pivot post from a lower end of the bonding part toward an axially lower side, and a length of the bonding part in an axial direction is greater than a length of the inclined part in the axial direction.
(8) In the base plate according to (7), at least a portion of the bonding part is impregnated with an impregnating agent.
(9) In the base plate according to (7), a sealing member is disposed at a gap between the inclined part and the pivot post.
(10) A spindle motor includes the base plate according to any one of (1) to (9).
(11) A disk drive device includes: the spindle motor according to (10); a disk, rotating, with the rotation axis as a center, by using the spindle motor; and a head, swinging with the swing axis as a center and performing information reading or information writing with respect to the disk.
(12) In the disk drive device according to (11), a gas whose density is lower than air is filled into the housing.
(13) A method for manufacturing a base plate as a portion of a housing of a disk drive device sequentially includes: a casting process of placing a pivot post in a mold to inject molten metal and forming a die-cast part having a bottom surface part spreading vertically with respect to a rotation axis of a disk extending in an upper-lower direction, the pivot post extending in the upper-lower direction by protruding upward from an upper surface of the bottom surface part along a swing axis of a head that performs information reading or information writing with respect to a disk; a removing process of removing a gate mark part linked with the die-cast part; an electro-coating process of forming an electro-coating film on a surface of the die-cast part.
(14) The method for manufacturing the base plate according to (13) sequentially has, after the electro-coating process: a cutting process of cutting and shaping the surface of the die-cast part; and an impregnating process of impregnating with an impregnating agent a machined surface where the surface of the die-cast part is exposed from the electro-coating film and a bonding part bonded to the pivot post of the die-cast part.
(15) In the method for manufacturing the base plate according to (14), the die-cast part has an inclined part inclined in a direction away from the pivot post from a lower end of the bonding region to a radially lower side, and the method for manufacturing the base plate has, after the impregnating process, a sealing process of disposing a sealing member at a gap between the inclined part and the pivot post.

### INDUSTRIAL UTILITY

The invention can be utilized for a housing used in a disk drive device, such as a hard disk drive.

### REFERENCE SIGNS LIST

1, 100: Disk drive device;
2: Spindle motor;
10: Stationary part;
12: Stator;
12a: Stator core;
12b: Coil;
12c: Tooth;
13: Bearing unit;
20: Rotation part;
21: Shaft;
22: Hub;
22a: Outer peripheral part;
23: Magnet;
30: Access part;
31: Head;
32: Arm;
32a: Bearing;
33: Swing mechanism;
40: Housing;
41, 410: Base plate;
41a, 410a: Metal plate;
41b, 410b: Die-cast part;
41c, 410c: Electro-coating film;
41d, 410d: Gate mark part;
41e, 410e: Gate mark part;
41f, 410f: Impregnating agent;
42: Cover;
50: Disk;
50a: Disk facing region;
72, 720: Machined surface;
201, 2010: Mold;
202, 2020: Mold;
201a, 2010a: Column-like concave part;
201b: Pedestal concave part;
202a, 2020a: Columnar part;
210, 2100: Cavity;
214, 2140: Gate;
411, 4110: Bottom wall part;
411a, 4110a: Bottom plate part;
411b: Bottom surface part;
412, 4120: Peripheral wall part;
412a, 4120a: Peripheral plate part;
412b: Peripheral surface part;
413, 4130: Pivot post;
413a: Flange part;
413b: Post groove part;
414: Connector window part;
415: Cylindrical wall part;
415a: Groove part;
411b: Pedestal part;
4112, 41120: Cylindrical part;
4112b: Bonding part;
4113: Stepped part;
4113a: Conductive wire through hole;
4113b: Inclined part;
4114: Bottom plate through hole;
4114b: Sealing member;
4115: Connector through hole;
4116: Pivot through hole;
4121: Peripheral plate through hole;
4122: Peripheral plate concave part;
4123: Peripheral plate groove part;
4124: Curved part;
4130a: Post through hole;
4131: Flange through hole;
C: Rotation axis;
D: Swing axis;
L1: Length;
I2: Length.

1. A base plate, configured as a portion of a housing of a disk drive device, wherein the base plate is formed by:
a metal plate, having a bottom plate part, wherein the bottom plate part has a plate shape and spreads vertically with respect to a rotation axis of a disk extending in an upper-lower direction; and
a die-cast part, covering at least a portion of the bottom plate part,
wherein a metal forming the bottom plate part is higher in rigidity than a metal forming the die-cast part.

2. The base plate as claimed in claim 1, wherein the bottom plate part has a cylindrical part disposed on the rotation axis, penetrates axially, and protrudes axially upward.

3. The base plate as claimed in claim 2, wherein an inner peripheral surface of the cylindrical part is covered by the die-cast part.

4. The base plate as claimed in claim 3, wherein a groove part extending in a peripheral direction is formed on an inner peripheral surface of the die-cast part disposed on the inner peripheral surface of the cylindrical part.

5. The base plate as claimed in claim 1, wherein the bottom plate part has a plurality of bottom plate through holes penetrating axially, and the die-cast part is filled into the bottom plate through holes, and
among the bottom plate through holes, a number of bottom plate through holes disposed on an inner side of a disk facing region formed on the bottom plate part by projecting the disk axially is fewer than a number of bottom plate through holes disposed on an outer side of the disk facing region.

6. The base plate as claimed in claim 1, wherein the bottom plate part has a stepped part, and the stepped part has an annular shape that protrudes axially upward to surround the cylindrical part, and
the stepped part has a plurality of conductive wire through holes penetrating axially and arranged in a peripheral direction.

7. The base plate as claimed in claim 1, wherein the metal plate further has a peripheral plate part, the peripheral plate part extends upward from an outer edge of the bottom plate part to surround a periphery of the bottom plate part, and at least a portion of the peripheral plate part is covered by the die-cast part, and
the peripheral plate part has a peripheral plate through hole, the peripheral plate through hole penetrates radially, and the die-cast part is filled into the peripheral plate through hole.

8. The base plate as claimed in claim 7, wherein the metal plate has a concave part into which the die-cast part is filled and in which a portion of the bottom plate part and the peripheral plate part is recessed inwardly across a boundary between the bottom plate part and the peripheral plate part, and
the concave part is disposed on a side opposite to a central axis by sandwiching a central line passing through a center of the bottom plate part in a longitudinal direction and extending in a transverse direction, the bottom plate part being formed in a substantially rectangular shape when viewed from an axial direction.

9. The base plate as claimed in claim 7, wherein the peripheral plate part has:
a curved part, curved along an edge of the disk when viewed from an axial direction,
the metal plate further has a flange part,
the flange part extends radially outward from an upper end of the curved part, and at least a portion of the flange part is covered by the die-cast part, and
the flange part has a flange through hole, the flange through hole penetrates axially, and the die-cast part is filled into the flange through hole.

10. The base plate as claimed in claim 7, wherein the peripheral plate part has a peripheral plate groove part on a bonding surface with the die-cast part.

11. The base plate as claimed in claim 7, wherein the die cast part covering the peripheral plate part has a gate mark part connected with a gate when being cast, and
a machined surface obtained by performing cutting machining on a surface of the die-cast part is formed to comprise at least a portion of the gate mark part.

12. The base plate as claimed in claim 11, wherein at least a portion of the machined surface is impregnated with an impregnating agent.

13. The base plate as claimed in claim 12, wherein the impregnating agent is an epoxy-based resin.

14. The base plate as claimed in claim 12, wherein the impregnating agent is an acrylic-based resin.

15. The base plate as claimed in claim 1, wherein the bottom plate part has a connector through hole which penetrates axially and through which a connector is drawn out, and
a portion of the connector through hole is covered by the die-cast part.

16. The base plate as claimed in claim 1, wherein the die-cast part and at least a portion of a surface of the metal plate that is exposed is covered by an electro-coating film.

17. A spindle motor, comprising the base plate as claimed in claim 1.

18. A disk drive device, comprising:
the spindle motor as claimed in claim 17,
the disk, rotating, with the rotation axis as a center, by using the spindle motor; and
a head, swinging with a swing axis as a center and performing information reading or information writing with respect to the disk.

19. A method for manufacturing a base plate as a portion of a housing of a disk drive device, the method sequentially comprising:
a casting process of injecting molten metal into a mold where a metal plate is placed to form a die-cast part covering at least a portion a bottom plate part and a peripheral plate part, the metal plate part having: the bottom plate part, having a plate shape spreading vertically with respect to a rotation axis of a disk extending in an upper-lower direction; and the peripheral plate part, extending upward from an outer edge of the bottom plate part to surround a periphery of the bottom plate part;
an electro-coating process of at least forming an electro-coating film on the die-cast part and a portion of the metal plate that is exposed; and
a cutting process of performing cutting machining on a surface of the die-cast part.

20. The method for manufacturing the base plate as claimed in claim 19, comprising, after the cutting process:
an impregnating process of impregnating a machined surface of the die-cast part obtained by performing cutting machining with an impregnating agent.
